(19) United States
(12) Patent Application Publication
(10) Pub. No.: US 2006/0190557 A1
(43) Pub. Date: Aug. 24, 2006

(54) Method and apparatus for forwarding user information among multiple information handling systems

(75) Inventors: Kulvir Singh Bhogal, Fort Worth, TX (US); Robert J. Kamper, Round Rock, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/064,622

(22) Filed: Feb. 24, 2005

(51) Int. Cl. G06F 15/16

(52) U.S. Cl. 709/217

(57) ABSTRACT

A networked system includes multiple information handling systems (IHSs) that store personal user information such as electronic business cards (EBCs). A first IHS stores the EBC of the EBC owner, namely the user of the first IHS. A second user operates a second IHS. When the second user attempts to forward the EBC to a third IHS operated by a third user, the second IHS instead sends an EBC request to the third IHS. The third user then forwards the EBC request back to the EBC owner's IHS if the third user desires to obtain the EBC. This provides the original owner of the EBC with the opportunity to reject or approve the request for the EBC. In this manner, the owner of the EBC effectively controls the downstream distribution of the owner's EBC when IHS users other than the owner attempt to forward the owner's EBC.

### CROSS REFERENCE TO RELATED PATENT APPLICATIONS

This patent application relates to the U.S. patent application entitled “Method and Apparatus For Task Scheduling In An Instant Messaging Environment”, inventors Kulvir Singh Bhogal and Robert J. Kamper, Attorney Docket No. AUS9-2004-0761 (S.N. to be assigned, filed on the same day as the subject patent application, and assigned to the same assignee), the disclosure of which is incorporated herein by reference in its entirety.

This patent application relates to the U.S. patent application entitled “Method and Apparatus For Communicating Multiple Activity Availability Status In An Instant Messaging Environment”, inventors Kulvir Singh Bhogal and Robert J. Kamper, Attorney Docket No. AUS9-2004-0762 (S.N. to be assigned, filed on the same day as the subject patent application, and assigned to the same assignee), the disclosure of which is incorporated herein by reference in its entirety.

This patent application relates to the U.S. Patent Application entitled “Method and Apparatus For Updating Information Stored In Multiple Information Handling Systems”, inventors Kulvir Singh Bhogal and Robert J. Kamper, Attorney Docket No. AUS9-2004-0763 (S.N. to be assigned, filed on the same day as the subject patent application, and assigned to the same assignee), the disclosure of which is incorporated herein by reference in its entirety.

This patent application relates to the U.S. patent application entitled “Method and Apparatus For Restricting Instant Messaging During A Scheduled Event”, inventors Kulvir Singh Bhogal and Robert J. Kamper, Attorney Docket No. AUS9-2004-1050 (S.N. to be assigned, filed on the same day as the subject patent application, and assigned to the same assignee), the disclosure of which is incorporated herein by reference in its entirety.

### TECHNICAL FIELD OF THE INVENTION

The disclosures herein relate generally to communicating information among information handling systems, and more particularly to communicating personal user information among multiple information handling systems.

### BACKGROUND

Networks of information handling systems (IHSs), such as computing devices, laptop computers, notebook computers, telephones, cellular phones and personal digital assistants continue to grow and proliferate. These IHSs frequently include personal information manager (PIM) applications or contact manager applications that store personal information of IHS users. A PIM application in a particular IHS may store the personal contact information of several IHS users with whom the user of that IHS desires to communicate. The stored personal information may include a user's name, street address, phone number, email address, as well as comments and other personal information. One simple way to create an address book of personal user information in a PIM application is for the IHS user to manually input the user information of other users with whom the user desires to communicate.

Another way to input user information is to store an electronic business card (EBC) received from another user via the network. Today's electronic business cards include personal user information intended for use by PIM applications. The vCard format provides a standard file structure for personal data interchange, namely a format for electronic business cards (vCard is a trademark of the Internet Mail Consortium). IHS users often attach their electronic business cards to email messages sent to other IHS users. The recipient of an electronic business card simply saves the card in the recipient's PIM application to avoid manually inputting the personal information contained in the card. This advantageously reduces the workload of the card user/recipient and reduces the likelihood of user-introduced error. However, one significant disadvantage of this approach is that the recipient can freely forward the electronic business card to other users without the approval of the owner of the electronic business card. The owner of the electronic business card typically loses control of the electronic business card once the owner sends the card to the recipient.

What is needed is a method and apparatus that provides the owner of personal user information with increased control of that information when the owner sends the information to a recipient.

### SUMMARY

Accordingly, in one embodiment, a method is disclosed for operating an information handling system (IHS). The method includes a first IHS storing first user information in a first address book that is operable by a first user. The first user information includes information related to the first user. The method also includes a second IHS storing the first user information in a second address book that is operable by a second user. The second address book also stores second user information related to the second user. The method further includes the second IHS forwarding a request for the first user information to a third IHS. The method still further includes the third IHS forwarding the request to the first IHS. The method also includes the first IHS transmitting the first user information to the third IHS at the option of the first user in response to the request.

In another embodiment, a networked system is disclosed including a first IHS that stores first user information in a first address book. The first IHS is operable by a first user. The first user information includes information that is related to the first user. The system also includes a second IHS that stores the first user information in a second address book that is operable by a second user. The second address book also stores second user information that is related to the second user. The system further includes a third IHS that stores a third address book that is operable by a third user. The system still further includes a network infrastructure that couples the first, second and third IHSs together. The second IHS is configured to forward a request for the first user information to the third IHS. The third IHS is configured to forward the request back to the first IHS. The first IHS is configured to transmit the first user information to the third IHS at the option of the first user in response to the request.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of one embodiment of a networked system using the disclosed user information forwarding methodology.

FIG. 2 shows a block diagram of a general purpose information handling system that can be used as clients and servers in the disclosed network system.

FIGS. 3A-3C together form a flow chart that depicts process flow in the disclosed IHS user information forwarding methodology.

### DETAILED DESCRIPTION

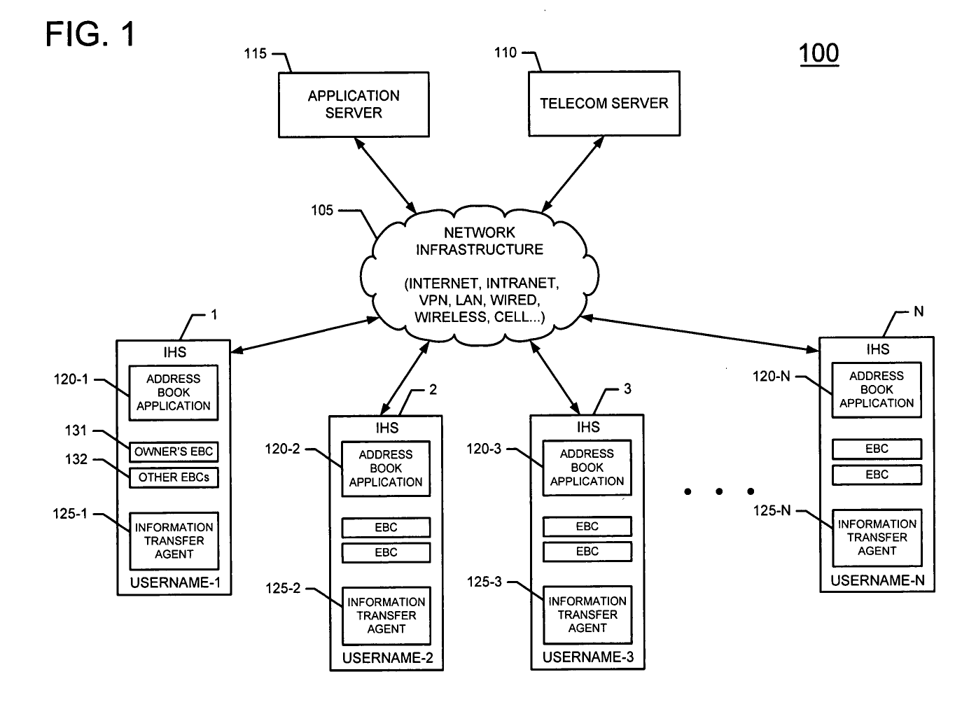

FIG. 1 shows a block diagram of a representative networked system 100 that implements the disclosed technology. System 100 includes information handling systems (IHSs) 1, 2, 3 . . . N wherein N is the total number of IHSs in the system. User IHSs 1, 2, 3 . . . N may include personal computer systems, laptops, notebooks, personal digital assistants, cellular phones and other networkable devices. Networkable devices connect to one another to communicate information. In FIG. 1, network infrastructure 105 couples IHSs 1, 2, 3 . . . N together via wire and/or wireless technology. Network infrastructure 105 may include networking structures such as the Internet, an intranet, a virtual private network (VPN), a local area network (LAN), a wide area network (WAN), wire-based networking structures and wireless networking structures such as cellular communication structures. The user names USERNAME-1, USERNAME-2, USERNAME-3 . . . USERNAME-N designate the names of the respective users of IHSs 1, 2, 3 . . . N. In one embodiment, system 100 includes a telecom server 110 that coordinates communication among user IHSs 1, 2, 3 . . . N. System 100 further includes an application server 115 that executes one or more server applications that IHSs 1, 2, 3 . . . N may access. In one embodiment, user IHSs 1, 2, 3 . . . N are client IHSs.

IHSs 1, 2, 3 . . . N each include an address book application 120 and an information transfer agent application 125. Address book application 120 stores users' personal information in a plurality of entries, each entry corresponding to information regarding a respective IHS user, namely USERNAME-1, USERNAME-2, USERNAME-3 . . . USERNAME-N. For example, each address book entry in address book application 120 of a particular IHS may include the name, street address, telephone number, e-mail address and other personal information regarding users with whom a particular user communicates. In one embodiment, the address book entries employ a predefined format such as the well known vCard format to store information as an electronic business card. (vCard is a trademark of the Internet Mail Consortium). The address book entries may employ other formats as well for electronic business cards as long as the other formats convey business card information and/or other personal user information. In one embodiment, address book application 120 employs Lotus Notes application software. (Lotus Notes is a trademark of IBM Corporation). Information transfer agent application 125 handles the forwarding of personal user information such as electronic business cards from IHS to IHS as described below in more detail.

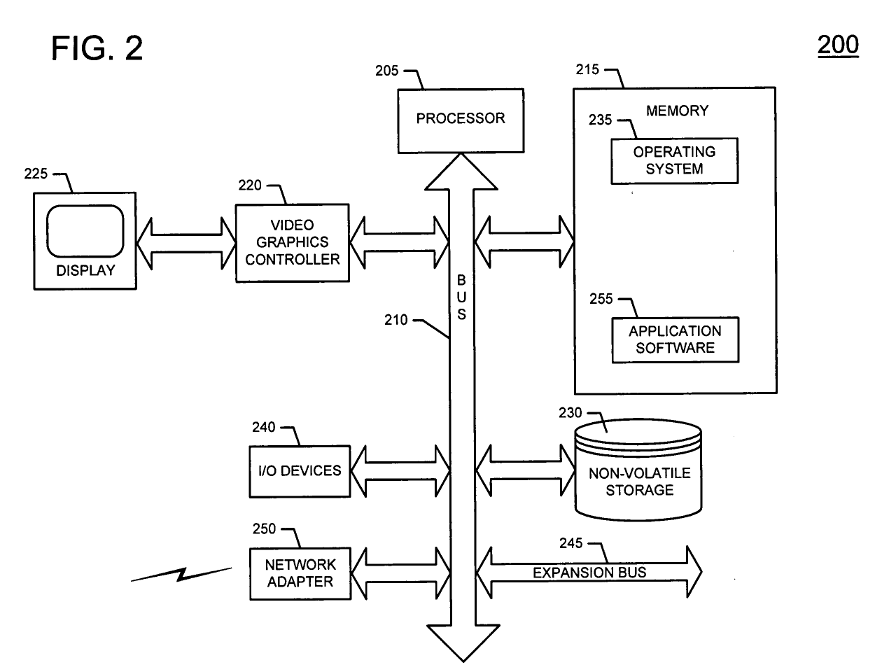

FIG. 2 shows a general purpose information handling system (IHS) 200 that networked system 100 may be employ as IHSs 1, 2, 3 . . . N, application server 115 and telecom server 110. Information handling system (IHS) 200 includes a processor 205. Bus 210 couples processor 205 to system memory 215 and video graphics controller 220. A display 225 couples to video graphics controller 220. Nonvolatile storage 230, such as a hard disk drive, CD drive, DVD drive, or other nonvolatile storage couples to bus 210 to provide IHS 200 with permanent storage of information. An operating system 235 loads in memory 215 to govern the operation of IHS 200. I/O devices 240, such as a keyboard and a mouse pointing device, couple to bus 210. One or more expansion busses 245, such as USB, IEEE 1394, ATA, SATA, PCI, PCIE and other busses, couple to bus 210 to facilitate the connection of peripherals and devices to IHS 200. A network adapter 250 couples to bus 210 to enable IHS 200 to connect by wire or wirelessly to network infrastructures such as network infrastructure 105 shown in FIG. 1.

IHS 200 loads application software 255 from nonvolatile storage 230 to memory 215 for execution. The particular application software 255 loaded into memory 215 of IHS 200 determines the functional characteristics of IHS 200. Networked system 100 employs multiple IHSs 200 configured as user IHS 1, 2, 3 . . . N, telecom server 110 and as application server 115. When IHS 200 acts as a user IHS such as IHS 1, IHS 200 loads address book application 120-1 and update agent 125-1 into system memory 215. Similarly, when IHS 200 acts as a telecom application server 110, IHS 200 loads telecom server application software into system memory 215. Likewise, when IHS 200 acts as application server 115, IHS 200 loads the desired application into system memory 215. For example, IHS 200 may load server application software such as an email server application and/or a personal information manager server application.

Returning to FIG. 1, IHSs 1, 2, 3 . . . N include respective personal information transfer agents 125-1, 125-2, 125-3 . . . 125-N, namely software applications that operate when one user's IHS communicates with another user's IHS. For example, IHS 1 communicates with IHS 2 via network infrastructure 105. In this example, USERNAME-1 operates IHS 1 and USERNAME-2 operates IHS 2. USERNAME-1, the owner of his or her electronic business card (EBC), sends that EBC from IHS 1 to USERNAME-2 at IHS 2. IHS 1 may transmit the EBC to IHS 2 as an attachment to an email message or alone. When USERNAME-2 receives the EBC at IHS 2, USERNAME-2 can save the data in the EBC in address book application 120-2. However, if USERNAME-2 attempts to forward USERNAME-1's EBC to USERNANE-3 at IHS 3, then information transfer agent 125-2 intervenes. Rather than forwarding USERNAME-1's EBC that includes all of USERNAME-1's personal information to USERNAME-3, information transfer agent 125-2 instead transmits an EBC request to USERNAME-3 at IHS 3. If USERNAME-3 desires to save USERNAME-1'S EBC in address book application 120-3, then USERNAME-3 sends the EBC request back to the EBC owner, namely USERNAME-1 at IHS 1. In one embodiment, the EBC request includes the information contained in Table 1 below:

TABLE 1
EBC REQUEST

EBC Owner
EBC Requester
EBC Forwarding History
EBC Time Stamp

The EBC owner in this example is USERNAME-1. The EBC requester is USERNAME-3. The EBC forwarding history includes the identity of all users in the EBC forwarding chain formed between the EBC owner, namely USERNAME-1, and the EBC requester, namely USERNAME-3. In this example, USERNAME-2 forwards the EBC request and thus the EBC forwarding history includes USERNAME-2 as well as USERNAME-1 and USERNAME-3. Other embodiments are contemplated wherein the forwarding chain includes multiple forwarders. The EBC request also includes the EBC Time Stamp, namely the date and time that USERNAME-1 sent the EBC to USERNAME-2.

When USERNAME-1 receives the EBC request from USERNAME-3, USERNAME-1 then instructs information transfer agent 125-1 to either accept or reject this request. If USERNAME-1 rejects the request, then USERNAME-3 receives no EBC from USERNAME-1. However, if USERNAME-1 accepts the EBC request, then information transfer agent 125-1 of IHS 1 sends USERNAME-1's current EBC to USERNAME-3 at IHS 3. In this manner, USERNAME-1 selectively controls the acceptance or rejection of EBC requests. Moreover, USERNAME-1 controls who receives USERNAME-1's EBC when attempts are made by others to forward USERNAME-1's EBC.

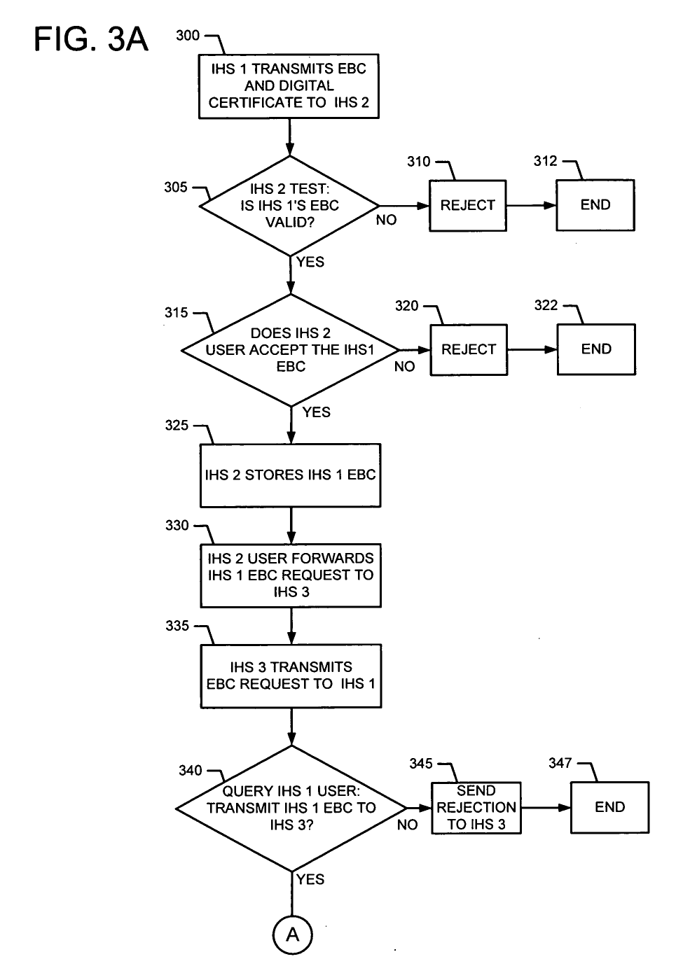

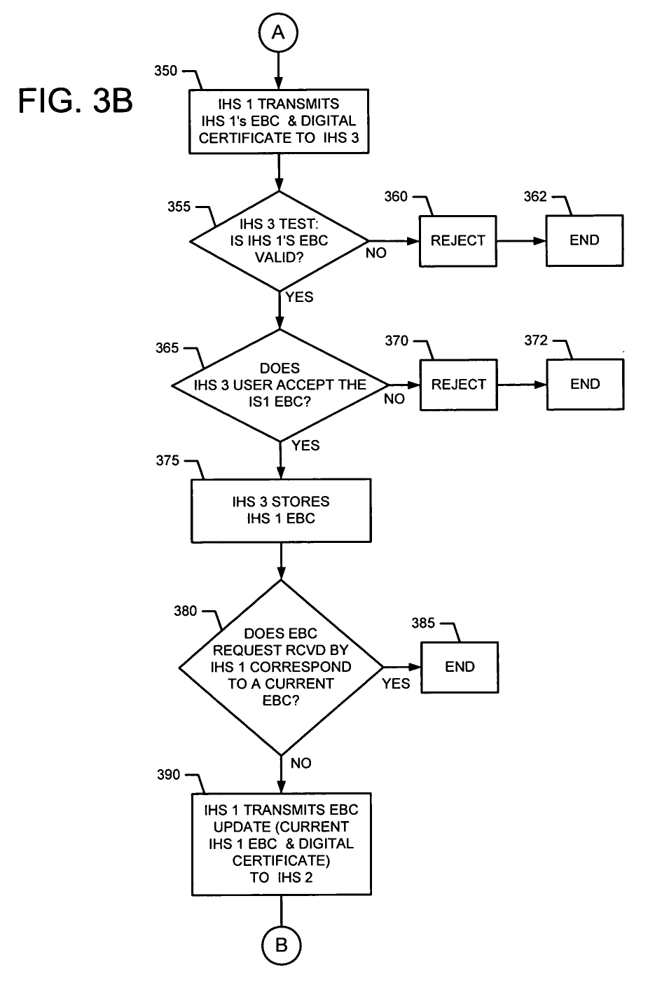

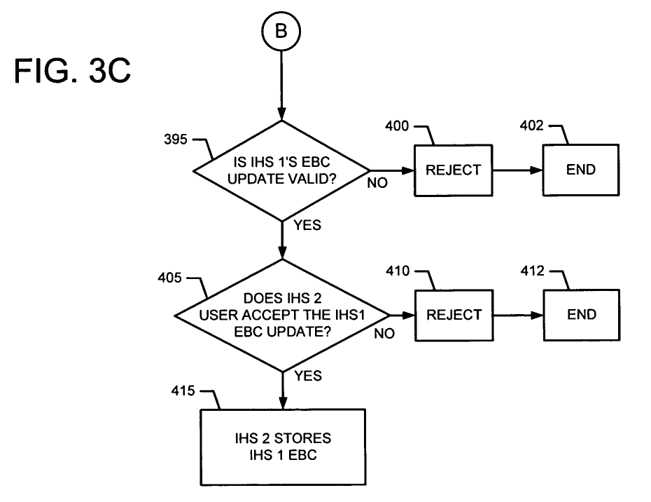

FIGS. 3A-3C together form a flow chart that depicts a representative process flow that information transfer agents 125-1, 125-2, 125-3 . . . 125-N may employ in the disclosed personal information entry forwarding process. In actual practice, software code in information transfer agents 125-1, 125-2, 125-3 . . . 125-N includes instructions that carry out the process depicted in this flow chart. Information transfer agents 125-1, 125-2, 125-3 . . . 125-N interact with address book applications 120-1, 120-2, 120-3 . . . 120-N as now described to retrieve and forward personal user information among the IHSs.

In this example, USERNAME-1 owns electronic business card (EBC) 131. EBC 131 includes USERNAME-1's name, street address, phone number, email address and/or other personal information. IHS-1 stores the owner's EBC 131 as well as other EBCs represented collectively as EBCs 132 in FIG. 1. In IHS 1, address book application 120-1 and information transfer agent 125-1 may both access EBC 131, namely USERNAME-1's EBC or the owner's EBC. USERNAME-1 at IHS 1 sends an email message to USERNAME-2 at IHS 2 as per block 300. This email message includes the owner's EBC 131, namely USERNAMES-1's EBC. In this example, USERNAME-1 wants USERNAME-2 to receive EBC 131, but does not want USERNAME-2 and others to freely distribute EBC 131 without USERNAME-1 's consent. Information transfer agent 125-1 sends a digital certificate along with the transmission of EBC 131 to USERNAME-2 to prove that EBC 131 comes from an authentic source, namely USERNAME-1.

Information transfer agent 125-2 receives EBC 131 at IHS 2 and conducts an authentication or validity test on the received digital certificate as per decision block 305. Decision block 305 analyzes the received digital certificate to determine the validity of the received EBC 131, namely to confirm that USERNAME-1 originated EBC 131. Information transfer agent 125-2 of IHS-2 rejects EBC 131, as per block 310, if the received digital certificate indicates invalidity. In that event the process ends, as per block 312, and IHS 2 continues with other information handling activities. However, if decision block 305 determines that EBC 131 is valid, then process flow continues to another decision block 315. At decision block 315 information transfer agent 125-2 asks USERNAME-2 if he or she accepts or rejects the received EBC 131. If USERNAME-2 rejects EBC 131, then agent 125-2 rejects EBC 131, as per block 320. In that event the process ends, as per block 322, and IHS 2 continues with other information handling activities. However, if decision block 315 determines that USERNAME-2 accepted the received EBC 131, then IHS 2 stores EBC 131 as per block 325. For example, IHS 2 stores EBC 131 in address book application 120-2 which exists both in memory 215 and non-volatile storage 230.

In this example, USERNAME-2 attempts to forward EBC 131 to another user, namely to the IHS 3 user (USERNAME-3) as per block 330. When USERNAME-2 makes this attempt to forward EBC 131, information transfer agent 125-2 intercepts this forwarding attempt and instead sends an EBC request to USERNAME-3. In one embodiment, the EBC request includes the items listed in Table 1 above. When IHS 3 receives the EBC request from IHS 2, USERNAME-3 at IHS 3 decides whether or not to request USERNAME-1's EBC. If USERNAME-3 desires USERNAME-1's EBC, then USERNAME-3 instructs information transfer agent 125-3 to transmit the EBC request to USERNAME-1 at IHS 1 as per block 335.

IHS 1 receives the EBC request sent by IHS 3. In response to receiving the EBC request, information transfer agent 125-1 queries USERNAME-1, namely the IHS 1 user, at decision block 340 to indicate whether or not USERNAME-1 desires to transmit the requested EBC 131 to IHS 3. If USERNAME-1 does not desire to send EBC 131 to USERNAME-3 at IHS 3, then USERNAME-1 so indicates to information transfer agent 125-1. In that event, information transfer agent 125-1 sends a rejection to IHS 3 as per block 345 and the process ends at block 347. However, if USERNAME-1 indicates to information transfer agent 125-1 that USERNAME-1 desires to send the requested EBC 131 to IHS 3, then process flow continues to block 350 of FIG. 3B. At block 350, IHS 1 transmits USERNAME-1's EBC 131 and digital certificate to USERNAME-3 at IHS 3.

In an alternative embodiment, rather than querying USERNAME-1 to accept or reject each request for an EBC update, USERNAME-1 can indicate to information transfer agent 125-1 that USERNAME-1 authorizes a predetermined group of users to receive EBC updates. USERNAME-1 thus pre-approves such groups for receipt of an EBC update. These pre-approved groups include departments, teams, committees and other business or non-business groups. Address book application 120-1 may include a check box in each address book entry so that USERNAME-1 can indicate that the user or addressee corresponding to that particular address book entry may receive an EBC update without querying USERNAME-1 with an EBC update request. In one embodiment, USERNAME-1 may indicate to information transfer agent 125-1 that USERNAME-1 consents to sending any user in USERNAME1'S address book application 120-1 an EBC update. As described above, USERNAME-1 may also indicate to information transfer agent 125-1 and/or address book application 120-1 that USERNAME-1 consents to sending EBC updates to selected groups of users stored in address book application 120-1 without separately requesting USERNAME-1's consent for each EBC update request.

Information transfer agent 125-3 of IHS 3 receives EBC 131 and the accompanying digital certificate. Information transfer agent 125-3 conducts a test at decision block 355 to determine if the received EBC 131 is valid. Information transfer agent 125-3 performs this test in the same manner that decision block 305 performed an EBC validity test as described above. If information transfer agent 125-3 determines that the received EBC is not valid, then agent 125-3 rejects the received EBC as per block 360 and the process ends at block 362. However, if information transfer agent 125-3 determines that the received EBC is valid, then decision block 365 conducts an acceptance test at decision block 365. Decision block 365 queries USERNAME-3 to determine if USERNAME-3 accepts the valid received EBC 131. If USERNAME-3 rejects EBC 131, then information transfer agent 125-3 rejects EBC 131 as per block 370 and the process ends at block 372. However, if USERNAME-3 accepts EBC 131, then information transfer agent 125-3 stores the data in EBC 131 as an entry in address book application 120-3 as per block 375.

The remaining blocks 380-415 of the flowchart of FIGS. 3A-3C relate to updating EBCs stored by IHSs in system 100. In one scenario, it is possible that a significant amount of time may transpire between the time that IHS 1 sends EBC 131 to IHS 2 and the time when the user of IHS 2 forwards an EBC request to IHS 3. Thus, by the time that the user of IHS 3 finally sends the EBC request back to the EBC owner, i.e. IHS 1, it is possible that the EBC stored by IHS 2 for USERNAME-1 may no longer be current or up-to-date. In other words, the EBC of USERNAME-1 in IHS 1 may be more recent than the EBC of USERNAME-1 stored in IHS 2 by address book application 120-2.

To handle the situation described above, decision block 380 performs a test to determine if the EBC for USERNAME-1 stored in address book application 120-2 of IHS 2 is current. Information transfer agent 125-1 performs this test by comparing the time stamp of USERNAME-1's EBC 131 in IHS 1 with the EBC time stamp contained in the EBC request that IHS 1 received from IHS-3. As discussed above with reference to Table 1, the time stamp in the EBC request includes the time and date of the EBC sent by IHS 1 to IHS 2. Decision block 380 examines the time stamp in the EBC request received from IHS 3 to determine the up-to-date or out-of-date status, i.e. the current or non current nature, of the IHS 1 EBC stored by IHS 2. If decision block 380 determines that the time stamp in the EBC request received by IHS 1 from IHS 3 contains the same time stamp as USERNAME-1's EBC in IHS 1, then the EBC stored in IHS-2 for USERNAME-1 is current. In this event the process ends, as per block 385, without IHS 1 sending an EBC update to IHS-2. However, if decision block 380 determines that the EBC request received by IHS 1 from IHS 3 does not contain the same time stamp as the time stamp of USERNAME-1's EBC in IHS 1, then the EBC stored in IHS-2 for USERNAME-1 is not current. In this event, IHS 1 sends an EBC update to IHS 2 as per block 390. More specifically, IHS 1 sends IHS 2 an EBC update including the current EBC entry in address book application 120-1 for USERNAME-1.

Information transfer agent 125-2 of IHS 2 receives the EBC update from IHS 1. Upon reception of the EBC update, information transfer agent 125-2 determines the validity of the EBC update as per decision block 395 in FIG. 3C. Agent 125-2 performs a validity test on the digital certificate accompanying the EBC update in the same manner as performed above in decision block 355. If decision block 395 determines the EBC update from IHS 1 to be invalid, then agent 125-2 rejects the EBC update as per block 400 and the process ends at block 402. However, if decision block 395 determines the EBC update to be valid, then process flow continues to decision block 405. Decision block 405 queries USERNAME-2 of IHS 2 to either accept or reject the EBC update. If USERNAME-2 rejects the EBC update, then agent 125-2 of IHS 2 rejects the EBC update, as per block 410, and the process ends at block 412. However, if decision block 405 determines that the user accepts the EBC update, then agent 125-2 stores the EBC update for USERNAME-1 as an entry in address book application 120-2 as per block 415. At the option of USERNAME-2, the EBC update may overwrite the old EBC entry for USERNAME-1 in address book application 120-2 in IHS 2 or IHS 2 may add the EBC update as another entry in address book application 120-2. Thus, in the scenario described above, IHS 1 provides IHS 2 with an up-to-date EBC when IHS 1 finds an out-of-date IHS 1 EBC stored in IHS 2. Moreover, IHS 1 populates IHS 3 with an up-to-date EBC upon receiving and accepting an EBC request from IHS 3.

Those skilled in the art will appreciate that the methodologies disclosed, such as seen in the flow charts of FIGS. 3A-3C, can be implemented in hardware or software. Moreover, the methodologies represented in FIGS. 3A-3C may be embodied in a computer program product, such as a media disk, media drive or other storage media, or may be divided among multiple computer program products.

In one embodiment, the disclosed methodology is implemented as a client application, namely a sets of instructions (program code) in a code module which may, for example, be resident in the system memory 215 of system 200 of FIG. 2. Until required by the particular system 200, the set of instructions or program code may be stored in another memory, for example, non-volatile storage 230 such as a hard disk drive, or in a removable memory such as an optical disk or floppy disk, or downloaded via the Internet or other computer network. Thus, the disclosed methodology may be implemented in a computer program product for use in a client information handling system such as IHS 1, 2, 3 . . . N. It is noted that in such a software embodiment, code which carries out the functions described in the flowchart of FIGS. 3A-3C, may be stored in RAM or system memory 215 while such code is being executed. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

The foregoing discloses a networked system including multiple IHSs connected to one another by a network infrastructure. The IHSs include address book applications that store user personal information such as electronic business cards. The IHSs also include information transfer agents that control the distribution and forwarding of user information such as electronic business cards from IHS to IHS. The information transfer agent in an IHS empowers the information owner to control downstream distribution and forwarding of the owner's personal information.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of operating information handling systems (IHSs), the method comprising:
storing, by a first IHS, first user information in a first address book that is operable by a first user, the first user information including information related to the first user;
storing, by a second IHS, the first user information in a second address book that is operable by a second user, the second address book also storing second user information related to the second user;
forwarding, by the second IHS, a request for the first user information to a third IHS;
forwarding, by the third IHS, the request to the first IHS; and
transmitting, by the first IHS, the first user information to the third IHS at the option of the first user in response to the request.

2. The method of claim 1, wherein the transmitting step comprises transmitting the first user information to the third IHS if the first user accepts the request.

3. The method of claim 1, wherein the transmitting step comprises transmitting a rejection to the third IHS if the first user rejects the request.

4. The method of claim 1, wherein the first user information comprises an electronic business card.

5. The method of claim 1 further comprising transmitting, by the first IHS, a digital certificate to the third IHS with the first user information.

6. The method of claim 5 further comprising determining, by the third IHS, the validity of the first user information by testing the digital certificate.

7. The method of claim 6 further comprising rejecting, by the third IHS, the first user information if the first user information is invalid.

8. The method of claim 6 further comprising accepting, by the third IHS, the first user information if the first user information is valid.

9. The method of claim 1, wherein the request forwarded by the second IHS includes a time stamp for the first user information stored in the second address book.

10. The method of claim 9 including determining, by the first IHS, if the first user information stored in the second address book is current.

11. The method of claim 10 wherein the determining is performed by the first IHS comparing the time stamp in the request with a time stamp of the first user information in the first address book.

12. The method of claim 10 including updating the first user information in the second address book if the first user information in the second address book is not current.

13. A networked system comprising:
a first information handling system (IHS) that stores first user information in a first address book that is operable by a first user, the first user information including information related to the first user;
a second IHS that stores the first user information in a second address book that is operable by a second user, the second address book also storing second user information related to the second user;
a third IHS that stores a third address book that is operable by a third user; and
a network infrastructure coupling the first, second and third IHSs together; wherein the second IHS is configured to forward a request for the first user information to the third IHS, the third IHS is configured to forward the request to the first IHS, and the first IHS is configured to transmit the first user information to the third IHS at the option of the first user in response to the request.

14. The networked system of claim 13, wherein the first user information comprises an electronic business card.

15. The networked system of claim 13, wherein the first IHS is configured to transmit a digital certificate to the third IHS with the first user information.

16. The networked system of claim 15, wherein the third IHS is configured to determining the validity of the first user information by testing the digital certificate.

17. The networked system of claim 13, wherein the request forwarded by the second IHS includes a time stamp for the first user information stored in the second IHS.

18. The networked system of claim 17, wherein the first IHS is configured to compare the time stamp in the request with the time stamp of the first user information in the first address book to determine if the first user information stored in the second address book is current, and wherein the first IHS is further configured to update the first user information in the second address book if the first user information in the second address book is not current.

19. A computer program product stored on a computer operable medium for transferring first user information, the computer program product comprising:
instructions for storing first user information in a first address book in a first information handling system (IHS) that is operable by a first user, the first user information including information related to the first user;
instructions for storing the first user information in a second address book in a second IHS that is operable by a second user, the second address book also storing second user information related to the second user;
instructions for forwarding, by the second IHS, a request for the first user information to a third IHS that is operable by a third user;
instructions for forwarding, by the third IHS, the request to the first IHS; and
instructions for transmitting, by the first IHS, the first user information to the third IHS at the option of the first user in response to the request.

20. The computer program product of claim 19 wherein the first user information comprises an electronic business card.
